(19) United States
(12) Patent Application Publication
(10) Pub. No.: US 2014/0222967 A1
(43) Pub. Date: Aug. 7, 2014

(54) TRANSPARENT MEDIA DELIVERY AND PROXY

(71) Applicant: OPANGA NETWORKS, INC., Seattle, WA (US)

(72) Inventors: Jeffrey Paul HARRANG, Sammamish, WA (US); John BURNETTE, Seattle, WA (US); David GIBBONS, Redmond, WA (US); Nathan CLARK, Seattle, WA (US); Ethan NORDNESS, Seattle, WA (US)

(73) Assignee: OPANGA NETWORKS, INC., Seattle, WA (US)

(21) Appl. No.: 14/175,995

(22) Filed: Feb. 7, 2014

Related U.S. Application Data
(60) Provisional application No. 61/761,910, filed on Feb. 7, 2013.

(51) Int. Cl. H04L 29/08

(52) U.S. Cl. CPC H04L 67/10
USPC 709/219

(57) ABSTRACT

Systems and methods for selecting a delivery policy and/or protocol via which to delivery media and other content from a content provider to a receiving device, is described. In some embodiments, the systems and methods access a request from an application supported by a mobile device to receive a media file from a remote content server, select a delivery policy via which to deliver the media file from the remote content server to the application based on information associated with the media file, and cause the media file to be delivered from the remote content server to the application via the selected delivery policy.

### CROSS-REFERENCES TO RELATED APPLICATIONS

This application claims priority to U.S. Provisional Application No. 61/761,910, filed on Feb. 7, 2013 entitled SYSTEM AND METHOD FOR TRANSPARENT DEVICE MEDIA PROXY AND DELIVERY, which is hereby incorporated by reference in its entirety.

### BACKGROUND

Typically, media is delivered from a content provider to a receiving device via one of several streaming protocols, which compete with one another for available bandwidth over a communication network. Network communication stacks at sending and/or receiving nodes are customized to the various streaming protocols. In order to utilize the customized protocol stacks, user and system applications (e.g., YouTube™ client application, Android™ Media Server application, and so on) may be modified to realize the custom features provided by the customized stacks and/or various streaming protocols.

Often, such stack level modifications lead to modifications at the receiving device (e.g., mobile device or other user equipment) that is supporting the user and system applications, such as changes to a device operating system, changes to the system applications/services or user applications/services supported by the receiving device, and so on. Such changes may involve difficult technical integration tasks and/or complex and impractical business arrangements between competing business interests, among other problems. Additionally, with respect to infrastructure servers, customization of a protocol stack may involve changes to an operating system or server software that may be difficult to achieve, such as changes made after the servers are already deployed, among other drawbacks.

### BRIEF DESCRIPTION OF THE DRAWINGS

FIG. 1 is a block diagram illustrating a suitable computing environment.

FIGS. 2A-2C are block diagrams illustrating components supported by user equipment.

FIG. 3 is a block diagram illustrating components of a delivery agent.

FIG. 4 is a flow diagram illustrating a method for delivering a media file to a mobile device.

FIG. 5 is a flow diagram illustrating a method for delivering content from a remote content provider to a mobile device via a selected delivery policy.

FIG. 6 is a flow diagram illustrating a method for selecting a delivery policy for delivery of a media file to a requesting application.

### SUMMARY

In some embodiments, a method includes accessing a request from an application supported by a mobile device to receive a media file from a remote content server; selecting a delivery policy via which to deliver the media file from the remote content server to the application based on information associated with the media file; and causing the media file to be delivered from the remote content server to the application via the selected delivery policy.

In some embodiments, a system includes a request interception module that accesses a request from an application supported by a mobile device to transfer a media file between a remote content server and the application, a delivery policy determination module that selects a delivery policy via which to deliver the media file between the remote content server and the application based on information associated with the media file, and a delivery module that causes the media file to be delivered between the remote content server and the application via the selected delivery policy.

In some embodiments, a method includes accessing, at a firewall or media server supported by the user equipment, a request for content provided from an application supported by the user equipment, applying, at the firewall or media server, a set of interception rules stored at the firewall that are associated with intercepting media content requests, determining that the request satisfies the set of interception rules, relaying the request to a delivery agent supported by the user equipment, applying, at the delivery agent, a set of delivery rules associated with selecting a mode of delivery via which to transfer the content from the remote content provider to the application over a network, selecting a mode of delivery based on a comparison of the set of delivery rules and information associated with a size of the requested content, a type of the requested content, or a source providing the requested content, and causing, via the delivery agent, the remote content provider to deliver the content to the application via the selected mode of delivery.

### DETAILED DESCRIPTION

Systems and methods for selecting a delivery policy, mode of delivery, and/or protocol via which to deliver media and other content from a content provider to a receiving device, is described. In some embodiments, the systems and methods access a request from an application supported by a mobile device to receive a media file from a remote content server, select a delivery policy or mode of delivery via which to deliver the media file from the remote content server to the application based on information associated with the media file, and cause the media file to be delivered from the remote content server to the application via the selected delivery policy.

For example, the systems and methods may intercept a media request at a firewall supported by the mobile device, and redirect the request to a delivery agent supported by the mobile device when the information associated with the media file satisfies one or more interception rules stored at the firewall. The delivery agent may select a delivery policy by communicating with a remote delivery manager that manages delivery of content between multiple content providers and multiple mobile devices and receiving information from the remote delivery manager that identifies the selected delivery policy, such as a delivery policy associated with the utilization of surplus bandwidth in a network, a delivery policy associated with a certain quality of service level, a delivery policy associated with a certain level of security, and so on. The delivery agent causes the media file to be delivered from the remote content server to the application via the selected delivery policy by instructing the remote content provider to deliver the media file to the application via the selected delivery policy.

In some embodiments, the systems and methods may access, at a firewall supported by user equipment, a request for content provided from an application supported by the user equipment, apply, at the firewall, a set of interception rules stored at the firewall that are associated with intercepting media content requests, determine that the request satisfies the first set of interception rules, and relay the request to a delivery agent supported by the user equipment. Once the request is received at the delivery agent, the systems and methods may apply a set of delivery rules associated with selecting a delivery policy via which to transfer the content from the remote content provider to the application, select a delivery policy based on a comparison of the set of delivery rules and information associated with a size of the requested content, a type of the requested content, and/or a source providing the requested content, and cause the remote content provider to deliver the content to the application via the selected delivery policy.

Thus, in some embodiments, the systems and methods may enable, facilitate, and/or provide a non-network-impacting delivery of media content in a transparent manner, requiring minimal or no modifications to hardware or software components employed by the delivery policy or network that facilitates the content delivery, among other benefits.

In the following detailed description, reference is made to the accompanying drawings, which form a part of the description. The embodiments described in the detailed description, drawings, and claims are not meant to be limiting. Other embodiments may be utilized, and other changes may be made, without departing from the spirit or scope of the subject matter presented herein. It will be understood that the aspects of the present disclosure, as generally described herein and illustrated in the drawings, may be arranged, substituted, combined, separated, and designed in a wide variety of different configurations.

The technology can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term processor refers to one or more devices, circuits, and/or processing cores configured to process data, such as computer program instructions.

A detailed description of embodiments is provided below along with accompanying figures that illustrate the principles of the technology. The technology is described in connection with such embodiments, but the technology should not be limited to any embodiment. The scope of the technology is limited only by the claims and the technology encompasses numerous alternatives, modifications and equivalents. Numerous specific details are set forth in the following description in order to provide a thorough understanding of the technology. These details are provided for the purpose of illustration and the technology may be practiced according to the claims without some or all of these specific details. For the purpose of clarity, technical material that is known in the technical fields related to the technology has not been described in detail so that the technology is not unnecessarily obscured.

### Examples of the Network Environment

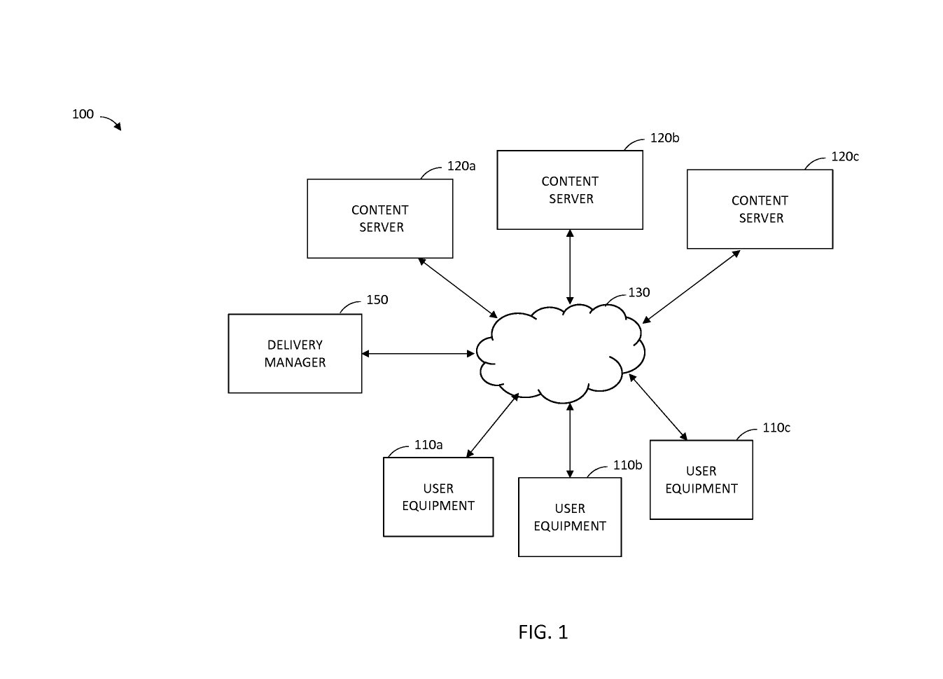

FIG. 1 is a block diagram illustrating a suitable network environment 100. The network environment 100 includes one or more user equipment 110a-c and one or more content servers 120a-c that communicate with one another over a data communication network 130.

The content servers 120a-c may provide a variety of different media and other content types, such as video content (e.g., movies, television shows, news programming, video clips), image content (e.g., image or picture slideshows), audio content (e.g., radio programming, music, podcasts), and so on. The content servers 120a-c may deliver, transfer, transport, and/or otherwise provide media files and other content to request devices via various media transfer protocols (e.g., Hypertext Transfer Protocol (HTTP), File Transfer Protocol (FTP), HTTP Live Streaming (HLS), HTTP Dynamic Streaming (HDS), HTTP Smooth Streaming (HSS), Dynamic Adaptive Streaming over HTTP (DASH), Real Time Streaming Protocol (RTSP), and so on).

The network 130 may be any network that enables communication between or among machines, databases, and devices. Accordingly, the network 130 may be a wide access network (WAN), wired network, a fiber network, a wireless network (e.g., a mobile or cellular network), a cellular or telecommunications network (e.g., WiFi, Global System for Mobile Communications (GSM), Universal Mobile Telecommunications System (UMTS), Long Term Evolution (LTE) network), or any suitable combination thereof The network 130 may include one or more portions of a private network, a public network (e.g., the Internet), or any suitable combination thereof.

The network environment 100 also includes a delivery manager 150, which directs or otherwise manages the delivery of content between devices, such as from the content servers 120a-c to the user equipment 110a-c, from the user equipment 110a-c to the content servers 120a-c, between user equipment (e.g., from user equipment 110a to user equipment 110c), between content servers (e.g., from content server 120b to content server 120c, and so on. The delivery manager 150 may, when instructed, track, store, and/or provide information associated with various network delivery policies and/or protocols utilized during the delivery of content over the network 130. Although the delivery manager 150 is depicted as being separate from the content servers 120a-c, any of the content servers 120a-c may include some or all components of the delivery manager 150.

In some embodiments, the delivery manager 150 directs or manages the delivery of content via a delivery policy that utilizes or uses surplus network bandwidth or surplus network capacity. A surplus of network bandwidth or network capacity may be network bandwidth or network capacity that is determined to be available (e.g., idle or free) in a network in view of the total capacity of the network and/or and the total usage of the network. In some embodiments, a network provider determines the amount of surplus network capacity available in a network in view of the total capacity of the network and/or and the total usage of the network. The surplus network capacity may be determined statically or dynamically, and, therefore, a determined surplus network capacity for a network may vary substantially and/or randomly over time (e.g., during peak use periods), for long or short time scales, and/or between one service provider to another.

For example, a network provider may set a threshold at a predetermined percentage of the total capacity of a network (e.g., 50%, 60%, 80%, 90%, 98%, and so on) of the total capacity). The surplus capacity, therefore, is the free bandwidth or capacity between an actual and/or current usage, and the predetermined percentage of the total capacity. For example, if the current usage of a network provider's capacity is 66%, and the predetermined percentage is 85%, the surplus network capacity is 19% of the bandwidth provided by that access provider (surplus capacity or bandwidth may be expressed in a variety of ways, such as a percentage of the total network capacity, as an absolute magnitude, or as any other suitable metrics).

Therefore, the delivery manager 150 may direct or manage the delivery of content between content providers 120a-c and user equipment 110a-c over various selected delivery policies or protocols that utilize free, available, idle, or otherwise surplus bandwidths or capacities of networks, such as paths or protocols that deliver data over currently underused networks that would not otherwise be in use, and/or without substantially impacting or altering the transport performance associated with other data traffic sharing the network.

Further details regarding the delivery of content using surplus network capacity may be found in commonly-assigned U.S. Pat. No. 7,500,010, issued on Mar. 3, 2009, entitled ADAPTIVE FILE DELIVERY SYSTEM AND METHOD, U.S. Pat. No. 8,589,585, issued on Nov. 19, 2013, entitled ADAPTIVE FILE DELIVERY SYSTEM AND METHOD, and U.S. Published Patent Application No. 2010/0198943, filed on Apr. 15, 2010, entitled SYSTEM AND METHOD FOR PROGRESSIVE DOWNLOAD USING SURPLUS NETWORK CAPACITY, all of which are hereby incorporated by reference in their entirety.

In some embodiments, the delivery manager 150 actively manages and/or controls the delivery of content between the remote content servers 120a-c and the user terminals 110a-c. For example, the delivery manager 150 receives radio network information and delivery performance data (such as packet throughput, radio signal and/or interference metrics) from the delivery agent 200. The delivery manager 150 coordinates with the delivery agent 200 to build a model of the network characteristics. Using the information received from the delivery agent 200, the delivery manager 150 generates control parameters and policies that are passed to the delivery agent 200. The delivery agent 200 may then enforce the control policies in order to manage the content delivery between the remote content servers 120a-c and the delivery agent 200.

Therefore, in some embodiments, the delivery manager 150 may act as an intermediary between content requesting applications (e.g., application 185, delivery agent 200), and/or proxy components (e.g., delivery agent 200 upon receiving an intercepted content request) and a content delivery network (CDN), such as a network of one or more remote content servers 120a-c. In such a role, the delivery manager 150 causes content delivery networks to deliver the requested content to the requesting applications or devices over a policy-enforced delivery session, without requiring the requesting applications or content delivery networks to be modified.

The user equipment 110a-c may include mobile devices (e.g., laptops, smart phones, tablet computers, and so on), computing devices, set-top boxes, vehicle computing devices, gaming devices, and so on. The user equipment 110a-c may support and run various different operating systems, such as Microsoft® Windows®, Mac OS®, Google® Chrome®, Linux®, Unix®, or any other mobile operating system, including Symbian®, Palm®, Windows Mobile®, Google® Android®, Mobile Linux®, and so on.

### Examples of Deploying a Delivery Agent in User Equipment

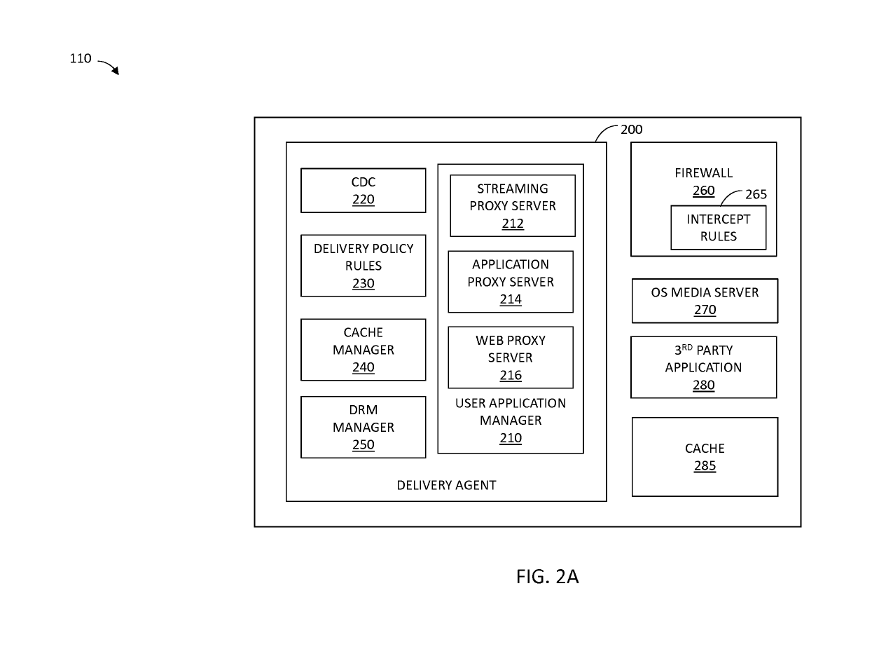

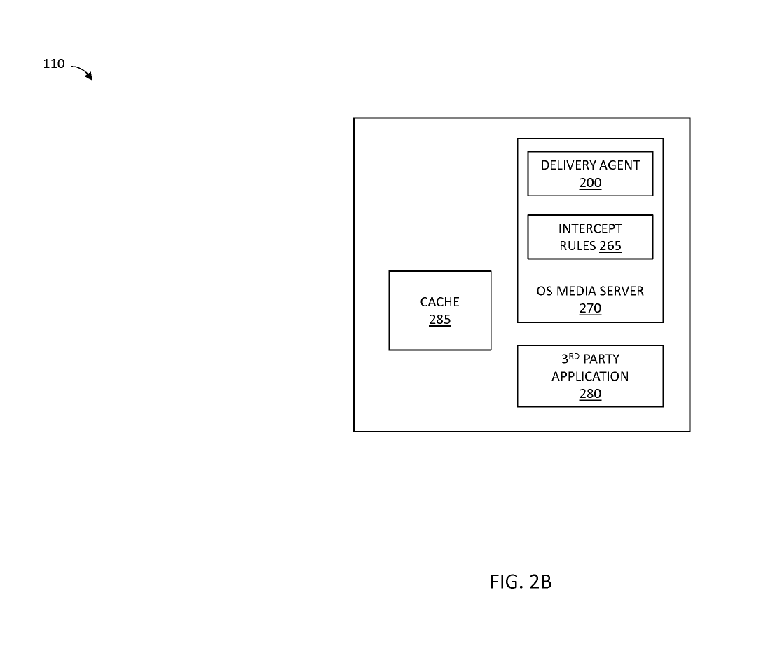

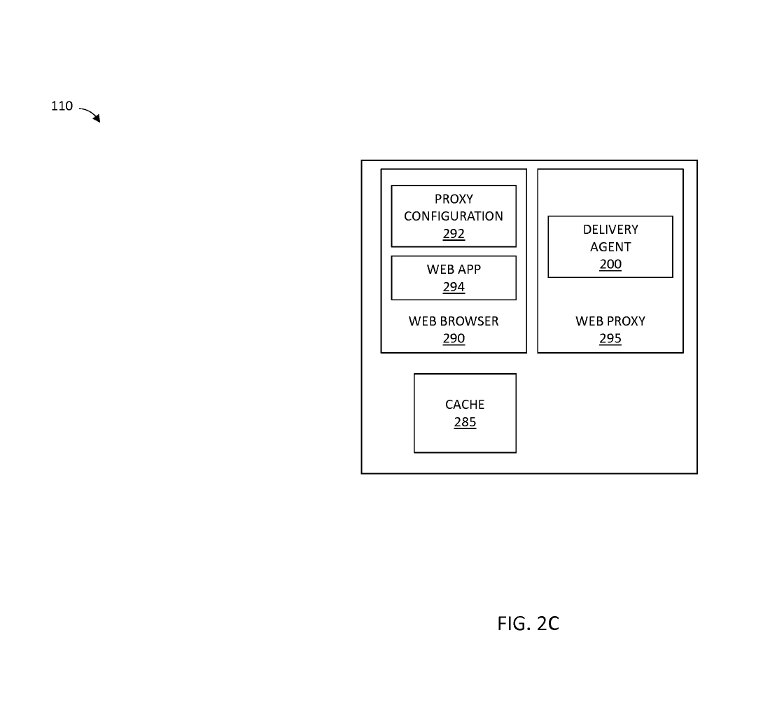

FIGS. 2A-2C are block diagrams illustrating components supported by the user equipment 110a-c. FIG. 2A depicts user equipment 110 that includes a separate supported delivery agent 200, along with a firewall 260 using intercept rules 265, a media server 270 provided by the operating system of the user equipment 110a-c, various 3^{rd} party applications 280 (e.g., apps downloaded to the user equipment 110a-c that are capable of streaming, displaying, or otherwise presenting media content), and a cache 285 or other temporary memory store.

In some embodiments, the delivery agent 200 include various components configured to and capable of managing the selection of delivery policies via which to deliver media content to/from the user equipment 110a-c and/or causing the delivery of media content to/from the user equipment 110a-c. The delivery agent 200 includes a user application manager 210 that may include a streaming proxy server 212, an application proxy server 214, and/or a web proxy server 216. The delivery agent 200 also includes a content delivery client (CDC) 220, stored delivery policy rules or instructions 230, a cache manager 240, which may temporarily store content in the cache 285 for a period of time (e.g., 24 hours or per a specific content policy) in anticipation of a subsequent content play or replay request, and, optionally, a digital rights management (DRM) manager 250.

The delivery agent 200, therefore, may be integrated into the delivery of content between the content servers 120a-c and applications running on the user equipment 110a-c. For example, content is delivered between the content servers 120a-c and the delivery agent 200, and then between the delivery agent 200 and the applications running on the user equipment 110a-c, such as 3^{rd} party application 280.

In some embodiments, the delivery manager 150 manages the delivery of content performed by the delivery agent 200. As described herein, the delivery manager 150 manages large numbers (e.g., thousands or millions of devices) of user equipment 110a-c and supported delivery agents 200, such as by managing the authentication, authorization and/or accounting functions associated with the delivery of content to the delivery agent 200. For example, the delivery manager 150 may manage payments associated with the delivery of content to requesting applications.

Thus the delivery agent 200 may conduct a transfer of media content from the content servers 120a-c to the delivery agent 200, based on information and/or control provided by the delivery manager 150. The delivery agent 200 may then forward and/or deliver received media content to requesting applications, as well as store some or all received content in the local cache 285 using the cache manager 240.

As described herein, the firewall 260 accesses or intercepts incoming and outgoing data traffic, and classifies and checks for data packets to be forwarded, blocked, and/or redirected by the firewall 260. In some embodiments, the firewall data forwarding policy is modified to include the intercept rules 265, such as rules that instruct the firewall to intercept some or all outgoing requests for content of a certain type (e.g., all media content) and forward or relay the requests to the delivery agent 200 for further handling.

For example, the forwarding policy (e.g., IPTABLES) of the firewall 260 (e.g., a Linux based OS firewall) may be configured with the following command:
iptables-t nat-A OUTPUT-o rmnet0-p tcp-m owner-uid-owner 1013-dport 80-j REDIRECT-to-ports 44441

The command adds a rule to an output rule chain (e.g., a rule chain that governs traffic leaving a device) within the forwarding policy of the firewall 260 to redirect all outbound TCP traffic for user ID 1013 (e.g., a media user associated with the OS media server 270) that is directed towards one of the mobile interfaces with a destination port 80, to a localhost:44441, a port monitored by the delivery agent 200. Of course, other interception points or proxy functions are possible, such as at other service access points within a device that examine and pass application traffic in and out of a device. Of course, the forwarding policy may utilize other filters and/or forwarding policies, such as the Berkeley Packet Filter (BPF) or other raw packet filters.

FIG. 2B depicts user equipment 110 having components in another configuration, where the delivery agent 200 and intercept rules 260 are supported by the media server 270 of the operating system of the user equipment 110. In such a configuration, an interception point may be within the OS Media Server 270 and be based on a registry of the user app UID for the third party application 280. Using such a configuration, for specific registered UID's, the OS Media Server 270 forwards requests from the application 280 to the delivery agent 200. Registration of the specific apps and their associated UIDs may be performed by the network operator or other parties.

As another example, the requesting application 280 may request specific media request handling via a special URL scheme, as follows:

special://example.cdn.com/video123.mp4,

where the OS Media Server 270 intercepts requested URLs having a scheme name of “special,” and redirects the intercepted requests to the delivery agent 200. The delivery agent 200 may then translate “special” to “http,” and transmit the request to the appropriate content server 120a-c, which delivers the request content using a delivery policy selected using some or all of the techniques described herein.

FIG. 2C depicts user equipment 110 having components in another configuration, where the delivery agent 200 is supported by a web proxy 295, and a web browser is configured to include a proxy configuration 292 and a web application 294. In such a configuration, the web proxy 295 may act as the interception point by intercepting requests for content that initiate from the web browser 290 (e.g., based on a configuration of the browser HTTP proxy URL) and relaying the requests to the delivery agent 200, which facilitates the delivery of the requested content to the web browser 290 via a delivery policy selected using some or all of the techniques described herein. Of course, other configurations of some or all aspects of the interception rules 265 and/or the delivery agent 200 with respect to requesting applications are possible. For example, in some embodiments, the web browser 290 may include and/or support the delivery agent 200, which may intercept and direct requests for content without utilizing separate or additional web proxy interception points.

Any of the machines, databases, or devices shown in FIGS. 1 and 2A-2C may be implemented in a general-purpose computer modified (e.g., configured or programmed) by software to be a special-purpose computer to perform the functions described herein for that machine, database, or device. Moreover, any two or more of the machines, databases, or devices illustrated in FIG. 1 may be combined into a single machine, and the functions described herein for any single machine, database, or device may be subdivided among multiple machines, databases, or devices.

Thus, in some embodiments, the system and methods, operating within the network environment 100, enables content providers to provide media content to requesting applications over a network without or with minimal equipment modification, by providing a delivery agent 200 or other intermediary that acts as a device-local transparent delivery proxy for the requested content delivery.

### Examples of Delivering Media Content to Requesting Applications

As described herein, in some embodiments, the delivery agent 200 receives intercepted requests for content from applications and causes delivery of the content via selected delivery policies or protocols, such as paths, modes, or protocols that utilize surplus or available bandwidth or capacity of access providers, among other things.

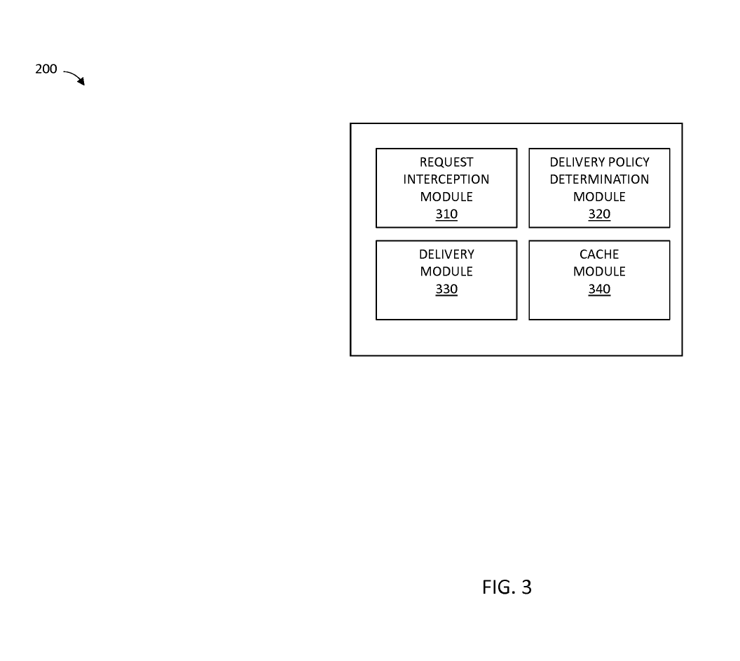

FIG. 3 is a block diagram illustrating the components of the delivery agent 200. In some embodiments, the delivery agent 200 may include one or more modules and/or components to perform one or more operations of the delivery agent 200. The modules may be hardware, software, or a combination of hardware and software, and may be executed by one or more processors. For example, the delivery agent 200 may include a request interception module 310, a delivery policy determination module 320, a delivery module 330, and/or a cache module 340.

In some embodiments, a request interception module 310 is configured and/or programmed to access a request from an application supported by a mobile device to receive or transfer a media file from or to a remote content server. For example, the request interception module 310 may intercept any requests received at a firewall supported by the mobile device that satisfy intercept rules 265 stored at the firewall.

Exemplary interception rules 265 include a rule to intercept all requests associated with a certain type of content (such as video, audio, or other media content), a rule to intercept all requests associated with a certain source of content or requestor, a rule to intercept all requests having certain keywords or other indicators, a rule to intercept all requests originating from a group or class of selected third party applications, and so on. For example, the interception rules 265 may include a table or other data structure that identifies one or more third party applications 280 registered with a service that provides the delivery agent 200 in order to handle the delivery and transfer of media to and from the applications. The interception rules 265 may include information identifying such applications 280, and cause the delivery agent 200 to act as a proxy for some or all selected applications that register with or otherwise choose to utilize the methods and systems described herein.

In some embodiments, the delivery policy determination module 320 is configured and/or programmed to select a delivery policy and/or mode via which to deliver the media file from the remote content server to the application and/or from the application to the remote content server based on information associated with the media file and/or associated network information, such as network performance metrics. For example, the delivery policy determination module 320 may select a delivery policy based on information associated with a size of the media file, information associated with a source providing the media file, and/or information associated with a type of the media file. The delivery policy determination module 320 may select the delivery policy based on a comparison of the information associated with the media file to the delivery policy rules 230 stored at the delivery agent 200 supported by the mobile device. In some embodiments, the delivery policy determination module 320 may select a delivery policy based on network performance metrics, such as coverage throughput, wireless radio metrics, network type, network infrastructure topology, and so on

In some embodiments, the delivery policy is the mode, method, way, channel or other manner or policy via which content is transported between a sender or a receiver. For example, a selected delivery policy may relate to a surplus capacity or bandwidth of a network, irrespective of any specific nodes or network components that form the network.

Therefore, in some embodiments, the delivery policy determination module 320 selects a mode of delivery policy that utilizes surplus network bandwidth within a network, such as when the information associated with the media file indicates a size of the media file is above a certain threshold value or other information associated with the media file.

In some embodiments, the delivery policy determination module 320 selects a delivery policy associated with a differentiated (high or low) quality of service when the information associated with the media file identifies a source providing the media file that utilizes certain quality of service network channels, or other information associated with the media file. The delivery policy, therefore, relates to a channel or mode of delivery having the differentiated quality of service, irrespective of any specific nodes or network components that form the network.

In some embodiments, the delivery module 330 is configured and/or programmed to cause the media file to be delivered from the remote content server to the application and/or from the application to the remote content server via the selected delivery policy. For example, the delivery module 330 may include and/or utilize the user application manager 210 of the delivery agent 200, including the application proxy server 214 that causes the media file to be delivered from the remote content server to a requesting application via the selected delivery policy.

In some embodiments, the cache module 340 is configured and/or programmed to query the cache 285 supported by the mobile device to identify whether at least a portion of the media file is stored in the cache. For example, the delivery agent 200 may instruct the cache module 340 to query the cache 285 in order to identify whether requested content is stored in the cache 285, and then cause a cached portion of the media file to be delivered from the cache 285 to the requesting application. Therefore, the delivery agent 200 may manage delivery of content to the requesting application by directing delivery a portion of the content from the cache 285 to the requesting application and directing delivery of other portions of the content from the remote content servers 120a-c, as needed or requested by the requesting application.

The delivery agent 200 may cause the delivery of content from the content servers 120a-c to the requesting application using a variety of different scenarios. Exemplary scenarios include:

Pre-caching content from the content server 120c over the network 130 to the cache 285;

Streaming content from the content server 120c over the network 130 to the streaming proxy server 212 of the user application manager 210 of the delivery agent 200, which delivers the content to the requesting application 280 via the firewall 260;

A combination of caching and streaming the content, by first pre-caching the content from the content server 120c over the network 130 to the cache 285, and then streaming the content from the cache 285 to the streaming proxy server 212 of the user application manager 210 of the delivery agent 200, which delivers the content to the requesting application 280 via the firewall 260; and so on. Of course, other scenarios are possible.

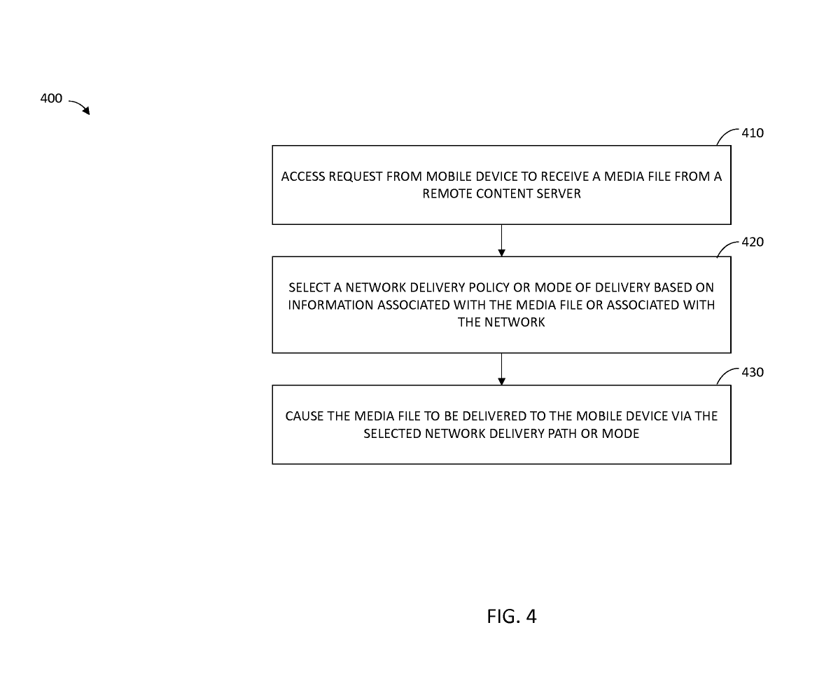

Thus, the systems and methods employ various methods and processes when delivering content between content servers 120a-c and user equipment 110a-c. FIG. 4 is a flow diagram illustrating a method 400 for delivering a media file to a mobile device. The method 400 may be performed by the delivery agent 200 and, accordingly, is described herein merely by way of reference thereto. It will be appreciated that the method 400 may be performed on any suitable hardware.

In operation 410, the delivery agent 200 accesses a request from an application supported by a mobile device to receive a media file from a remote content server. For example, the request interception module 310 may intercept any requests received at a firewall supported by the mobile device that satisfy intercept rules 265 stored at the firewall, any media content requests received by the OS media server 270, and so on, and redirect the request to the delivery agent 200 which accesses the request.

In operation 420, the delivery agent 200 selects a delivery policy or mode of delivery via which to deliver the media file from the remote content server to the application (or, from the application to the remote content sever) based on information associated with the media file and/or based on network information

For example, the delivery policy determination module 320 may select a delivery policy based on information associated with a size of the media file, information associated with a source providing the media file, and/or information associated with a type of the media file. The delivery policy determination module 320 may select the delivery policy based on a comparison of the information associated with the media file to the delivery policy rules 230 stored at the delivery agent 200 supported by the mobile device. In some embodiments, the delivery policy determination module 320 may select a delivery policy based on network performance metrics, such as coverage throughput, wireless radio metrics, network type, network infrastructure topology, and so on.

In some embodiments, the delivery policy determination module 320 selects a delivery policy or mode of delivery that utilizes surplus network bandwidth within a network, such as when the information associated with the media file indicates a size of the media file is above a certain threshold value or other information associated with the media file.

The delivery policy determination module 320 may communicate with the remote delivery manager 150, which manages delivery of content between multiple content providers and multiple mobile devices and receive information from the remote delivery manager 150 that identifies the selected delivery policy.

As described herein, the delivery policy determination module 320 may perform various different comparison of information associated with requested media content to delivery rules when selecting an appropriate delivery policy via which to deliver the content. Exemplary selections of delivery policies based on such comparisons include:

Selecting a delivery policy or mode of delivery that uses, utilizes, and/or is associated with surplus network bandwidth based on the information associated with the media file indicating a size of the media file is associated with utilizing surplus bandwidth in a network;

Selecting a delivery policy or mode of delivery that uses, utilizes, and/or is associated with surplus network bandwidth based on the information associated with the media file indicating a type of the media file that is associated with utilizing surplus bandwidth in a network;

Selecting a delivery policy or mode of delivery that uses, utilizes, and/or is associated with surplus network bandwidth based on the information associated with the media file indicating a source providing the media file is associated with utilizing surplus bandwidth in a network;

Selecting a delivery policy or mode of delivery having a parameter indicative of a historic quality of service exceeding (above or below) a certain threshold parameter for a quality of service associated with delivering the media file over a network;

Selecting a delivery policy or mode of delivery having a parameter indicative of a current quality of service above a certain threshold parameter for a quality of service associated with delivering the media file over a network;

Selecting a delivery policy or mode of delivery below a certain network congestion level associated with delivering data over the network via the delivery policy;

Selecting a first delivery policy via which to transfer an initial portion of the media file from the remote content server to the application and selecting a second, different, delivery policy via which to transfer a subsequent portion of the media file from the remote content server to the application; and combinations thereof. Of course, the delivery policy determination module 320 may perform other comparisons when selecting or otherwise determining a delivery policy via which to deliver content over the network 130.

In operation 430, the delivery agent 200 causes the media file to be delivered from the remote content server to the application (or, from the application to the remote content server) via the selected delivery policy. For example, the delivery module 330 may cause the delivery of the media file via one or more of the scenarios described herein. For example, the delivery module 330 may cause an initial portion of the media file to be delivered to the application from the cache 285, and cause a subsequent portion of the media file to be delivered from the remote content servers 120a-c, as needed.

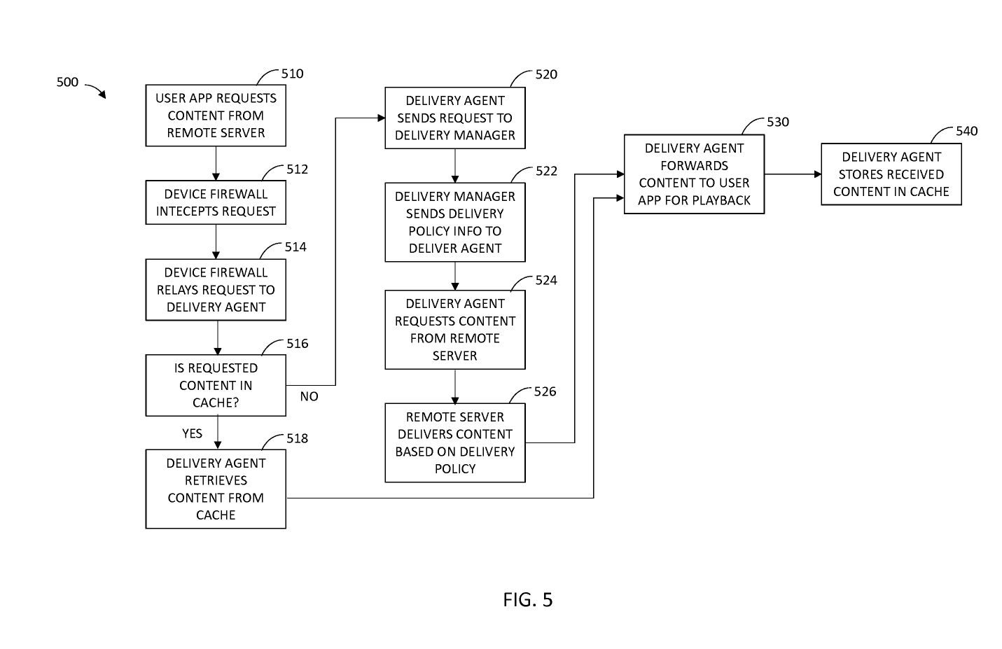

As described herein, in some embodiments, the delivery agent 200 acts as an intermediary between the content servers 120a-c and requesting applications. FIG. 5 is a flow diagram illustrating a method 500 for delivering content from a remote content provider to a mobile device via a selected delivery policy. The method 500 may be performed by the systems and methods described herein and, accordingly, is described herein merely by way of reference thereto. It will be appreciated that the method 500 may be performed on any suitable hardware.

In operation 510, a user application 280 requests content from a remote server (e.g., content server 120a). In operation 512, the device firewall 260 intercepts the request based on stored interception rules 265. In operation 514, the device firewall 260 relays the request to the delivery agent 200. In operation 516, the cache manager 240 determines whether the requested content is stored in the cache 285. When the cache manager 240 determines the requested content is stored in the cache 285, the method proceeds to operation 518, and the delivery agent retrieves the content from the cache 285.

When the cache manager 240 determines the requested content is not stored in the cache 285, the method proceeds to operation 520, and the delivery agent 200 sends a request to the delivery manager 150 for network information. In operation 522, the delivery manager 150 sends delivery policy information to the delivery agent 200, such as information identifying one or more delivery policies that include surplus network bandwidth.

In operation 524, the delivery agent 200 selects a delivery policy based on the techniques described herein, and requests the content from the remote server (e.g., content server 110a). In operation 526, the remote server 110a delivers the content over the selected delivery policy to the delivery agent 200. In operation 530, the delivery agent 200 forwards the delivered content to the user application 280 for playback, and, optionally, in operation 540, stores some or all of the content in the cache 285. The method 500 may perform some or all of the operations until playback of the requested content is completed.

As described herein, in some embodiments, the systems and methods apply interception rules 265 to outbound or inbound requests for content, and apply delivery policy rules 230 to intercepted requests in order to determine appropriate delivery policies via which to deliver content to or from a requesting application.

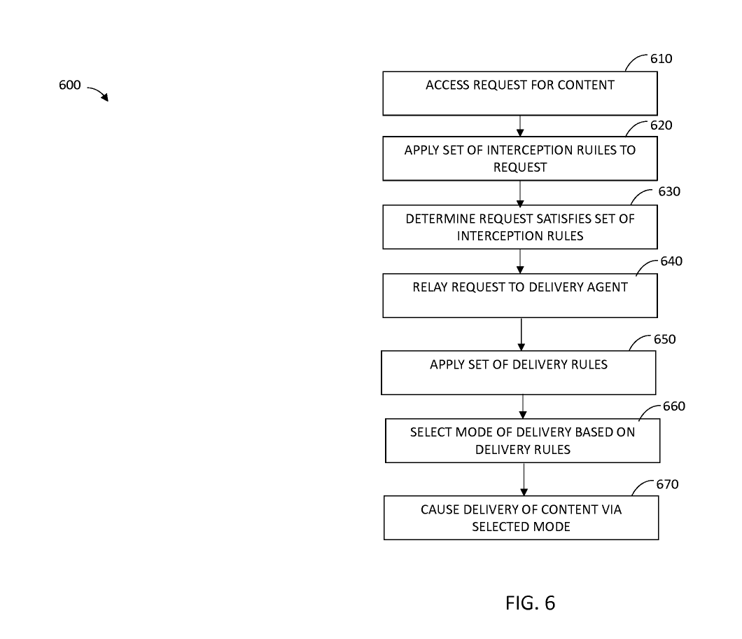

FIG. 6 is a flow diagram illustrating a method 600 for selecting a delivery policy for delivery of a media file to a requesting application. The method 600 may be performed by the systems and methods described herein and, accordingly, is described herein merely by way of reference thereto. It will be appreciated that the method 600 may be performed on any suitable hardware.

In operation 610, the system accesses, at a firewall supported by user equipment, a request for content provided from an application supported by the user equipment. In operation 620, the system applies, at the firewall, a set of interception rules stored at the firewall that are associated with intercepting media content requests. For example, the system may intercept any media content requests, any media content requests of a certain media type (e.g., from a video server), and so on.

In operation 630, the system determines that the request satisfies the set of interception rules. In operation 640, the system relays the request to the delivery agent 200 supported by the user equipment. In operation 650, the system applies, at the delivery agent, a set of delivery rules associated with selecting a delivery policy via which to transfer the content from the remote content provider to the application. In operation 660, the system selects a delivery policy based on a comparison of the set of delivery rules and information associated with a size of the requested content, a type of the requested content, and/or a source providing the requested content. For example, the system selects a delivery policy that delivery content over surplus bandwidth within a network. In operation 670, the system causes, via the delivery agent, the remote content provider to deliver the content to the application via the selected delivery policy.

Thus, in some example, embodiments, the systems and methods described herein provide methods for transparently intercepting data file delivery requests and managing the delivery of the data files without modifying content servers, user equipment, or other associated devices.

Although aspects of the present technology have been described with respect to specific examples, embodiments of the present technology are not limited by these examples. For example, persons of skill in the art will recognize that selecting media content delivery policies may be performed according to various algorithms without departing from the scope or spirit of the present technology.

What is claimed is:

1. A method, comprising:
accessing a request from an application supported by a mobile device to receive a media file from a remote content server;
selecting a delivery policy via which to deliver the media file from the remote content server to the application based on information associated with the media file; and
causing the media file to be delivered from the remote content server to the application via the selected delivery policy.

2. The method of claim 1, wherein accessing a request from a mobile device to receive a media file from a remote content server includes:
intercepting the request at a firewall of the mobile device; and
redirecting the request to a delivery agent operated by the mobile device when the information associated with the media file satisfies one or more interception rules accessed by the firewall; and
wherein selecting a delivery policy via which to deliver the media file from the remote content server to the application based on information associated with the media file includes:
communicating, via the delivery agent, with a remote delivery manager that manages delivery of content between one or more content providers and one or more mobile devices; and
receiving, at the delivery agent, information from the remote delivery manager that identifies the selected delivery policy;
wherein the delivery agent causes the media file to be delivered from the remote content server to the application via the selected delivery policy by instructing the remote content provider to deliver the media file to the application via the selected delivery policy.

3. The method of claim 1, wherein selecting a delivery policy via which to deliver the media file from the remote content server to the application based on information associated with the media file includes selecting a delivery policy that utilizes surplus network bandwidth via which to deliver at least a portion of the media file from the remote content server to the application based on the information associated with the media file indicating a size of the media file is associated with utilizing surplus bandwidth in a network.

4. The method of claim 1, wherein selecting a delivery policy via which to deliver the media file from the remote content server to the application based on information associated with the media file includes selecting a delivery policy that utilizes surplus network bandwidth via which to deliver at least a portion of the media file from the remote content server to the application based on the information associated with the media file indicating a type of the media file that is associated with utilizing surplus bandwidth in a network.

5. The method of claim 1, wherein selecting a delivery policy via which to deliver the media file from the remote content server to the application based on information associated with the media file includes selecting a delivery policy that utilizes surplus network bandwidth via which to deliver at least a portion of the media file from the remote content server to the application based on the information associated with the media file indicating a source providing the media file is associated with utilizing surplus bandwidth in a network.

6. The method of claim 1, wherein selecting a delivery policy via which to deliver the media file from the remote content server to the application based on information associated with the media file includes selecting a delivery policy having a parameter indicative of a quality of service exceeding a threshold parameter for a quality of service associated with delivering the media file over a network.

7. The method of claim 1, wherein selecting a delivery policy via which to deliver the media file from the remote content server to the application based on information associated with the media file includes:
selecting a first delivery policy via which to transfer an initial portion of the media file from the remote content server to the application; and
selecting a second, different, delivery policy via which to transfer a subsequent portion of the media file from the remote content server to the application.

8. The method of claim 1, wherein causing the media file to be delivered from the remote content server to the application via the selected delivery policy includes causing an initial portion of the media file to be delivered to a cache supported by the mobile device and causing a subsequent portion of the media file to be delivered to the application.

9. The method of claim 1, wherein selecting a delivery policy via which to deliver the media file from the remote content server to the application based on information associated with the media file includes communicating, via the delivery agent, with a remote delivery manager that manages delivery of content between one or more content providers and one or more mobile devices; and
wherein the delivery manager causes the media file to be delivered from the remote content server to the application via the selected delivery policy by instructing the remote content provider to deliver the media file to the delivery agent via the selected delivery policy.

10. The method of claim 1, wherein selecting a delivery policy via which to deliver the media file from the remote content server to the application based on information associated with the media file includes selecting a mode of delivering the media file from the remote content server to the application.

11. A system, comprising:
a request interception module that accesses a request from an application supported by a mobile device to transfer a media file between a remote content server and the application;
a delivery policy determination module that selects a delivery policy via which to deliver the media file between the remote content server and the application based on information associated with the media file; and
a delivery module that causes the media file to be delivered between the remote content server and the application via the selected delivery policy.

12. The system of claim 11, wherein the information associated with the media file includes information associated with a size of the media file, information associated with a source providing the media file, or information associated with a type of the media file.

13. The system of claim 11, wherein the delivery policy determination module selects a delivery policy that utilizes surplus network bandwidth within a network when the information associated with the media file indicates a size of the media file exceeds a certain threshold value.

14. The system of claim 11, wherein the delivery policy determination module selects a delivery policy associated with a certain quality of service when the information associated with the media file identifies a source providing the media file that utilizes certain quality of service network channels.

15. The system of claim 11, wherein the request interception module intercepts requests received at a firewall supported by the mobile device that satisfy intercept rules stored at the firewall.

16. The system of claim 11, wherein the delivery policy determination module selects the delivery policy based on a comparison of the information associated with the media file to delivery policy rules stored at a delivery agent supported by the mobile device.

17. The system of claim 11, wherein the request interception module intercepts a request from the application to deliver the media file from the remote content server to the application.

18. The system of claim 11, wherein the request interception module intercepts a request from the application to deliver the media file from the application to the remote content server.

19. The system of claim 11, further comprising:
a cache module that queries a cache supported by the mobile device to identify whether the media file is stored in the cache;
wherein the delivery module causes a cached portion of the media file to be delivered from the cache to the application.

20. A computer-readable storage medium whose contents, when executed by user equipment, cause the user equipment to perform operations comprising:
accessing, at a firewall or media server supported by the user equipment, a request for content provided from an application supported by the user equipment;
applying, at the firewall or media server, a set of interception rules stored at the firewall that are associated with intercepting media content requests;
determining that the request satisfies the set of interception rules;
relaying the request to a delivery agent supported by the user equipment;
applying, at the delivery agent, a set of delivery rules associated with selecting a mode of delivery via which to transfer the content from the remote content provider to the application over a network;
selecting a mode of delivery based on a comparison of the set of delivery rules and information associated with a size of the requested content, a type of the requested content, or a source providing the requested content; and
causing, via the delivery agent, the remote content provider to deliver the content to the application via the selected mode of delivery.

21. The computer-readable medium of claim 20, wherein the selected mode of delivery is a mode that transfers content using surplus bandwidth within a network.

22. The computer-readable medium of claim 20, further comprising:
selecting the mode of delivery based on one or more performance metrics associated with the network.
